(19) United States
(12) Patent Application Publication
(10) Pub. No.: US 2007/0084172 A1
(43) Pub. Date: Apr. 19, 2007

(54) Guidance indicator system for a cotton harvesting machine

(76) Inventors: Kevin S. Richman, Lititz, PA (US); Hyppolite Kuissi, Peoria, IL (US); Frank C. Dupire, Manheim, PA (US); Bruce A. Hadley, Ephrata, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/251,680

(22) Filed: Oct. 17, 2005

(51) Int. Cl. A01B 69/00

(52) U.S. Cl. 56/10.2 F

(57) ABSTRACT

A guidance indication system for use during the unloading of a load from a crop harvesting machine that determines a required steering correction as a function of wheel position when the machine is deviating from a desired path during the unloading process, and displays the steering correction to the operator.

### TECHNICAL FIELD

This invention relates generally to agricultural harvesting machines, and more particularly, to a guidance indicator system for a cotton harvesting machine when in an unloading mode which indicates when a corrective steering action is required and the direction of the corrective steering action.

### BACKGROUND ART

Agricultural harvesting machines, particularly cotton harvesting machines are able to unload a massive, compacted body of crop material which can presently be, for instance, as long as sixteen (16) feet in length and weigh greater than ten thousand (10,000) pounds. Such large bodies of cotton are typically unloaded over a foldable unloading ramp onto the ground in or adjacent to a field from which the cotton was just harvested.

Such large bodies of cotton, also referred to as cotton modules, are then typically picked up by another apparatus and transported to a cotton gin for processing or to a storage location. Because of the handling required and the potential that the cotton module may be exposed to environmental conditions such as rain and dust and also insect and rodent infestation, it is desired to maintain the integrity of the module when being unloaded such that it is not fractured or fragmented. The unloading ramp and other structure of the harvester are also at greater risk of being damaged if subjected to side loading conditions.

A problem that can occur when an unloading ramp is unfolded and the cotton holding structure is tilted for unloading is that if the harvester deviates from its initial straight ahead course, undesirable loads can be applied to both the unloading structure and the cotton module that can result in damage to one or both. The harvester, when in the unloading mode, with the unloading ramp extended, can be as long as forty (40) feet. And, during unloading, the harvester must be driven forwardly to unload the module onto the ground. The distance of forward travel will typically be about equal to the length of the module, which currently, is about sixteen (16) feet. The terrain over which the harvester must be driven is often irregular and typically can include ditches, rises, depressions, holes, vegetation and other conditions that make it difficult to maintain a straight ahead path with a degree of exactness sufficient to minimize side loads applied to the harvester and the module itself. Particularly if the cotton module is in a position partially on the unloading ramp and partially on the ground when a course deviation occurs, it can be subject to potential side loads sufficient to cause fracturing or even breakage.

As an additional problem, due to the overall size of the harvester and its length in the unloading mode with the ramp extended, it can be difficult for an operator to detect even small course deviations or the existence of potentially damaging conditions. Aggravating this fact, is that the area in the operator's field of vision may be devoid of reference points that can be focused on for maintaining a suitable course, or the unloading may also take place at night. The operator may also have to leave the cab or shift position during unloading such that reference points can be lost. Still further, present cotton harvesting machines are rear wheel steered, and operators may view the rear wheels in a mirror to ascertain straightness of course. However, some persons can be confused directionally when attempting to make course corrections using mirrors. As a result it has been found that there is a need for a simple guidance system for aiding the operator and drivers of cotton harvesters in closely maintaining an initial course when unloading.

Global positioning systems (GPS) and real-time kinematics (RTK) GPS are known for providing heading information including deviation from a pre-determined heading and also a corrective heading. Reference in this regard, Ahearn et. al, U.S. Pat. No. 6,553,311 issued on Apr. 22, 2003 to Trimble Navigation Limited. However, a shortcoming of such systems is that they require complex circuitry and the availability of a GPS and/or RTK infrastructure. Additionally, such known systems provide only corrective heading information, not steering information. This can be a shortcoming in instances wherein a vehicle is itself oriented in a correct heading direction while parked, but its steerable wheels may be in a different position or orientation, such that if movement is commenced the vehicle would move in a direction different than the GPS indicated heading. This is a particularly important consideration in the present application wherein the distance to be traveled is relatively short.

Thus, what is sought is a system which provides an indication when the vehicle is aligned to an initial course and provides real-time information representative of the steering correction required to return the vehicle to the initial course when a course deviation occurs, which is simple and easy to operate and otherwise overcomes one or more of the shortcomings set forth above.

### SUMMARY OF THE INVENTION

What is disclosed is a guidance indicator system and method for use with a harvesting machine during an unloading process which provides at least one of the advantages and overcomes at least one or more of the problems and shortcomings set forth above.

According to a preferred aspect of the invention, the guidance indication system and method signals or indicates when a steerable vehicle is varying from a path, by determining information representative of a steering position of at least one steerable wheel of the vehicle, and outputting a signal indicative of a corrective steering action for returning the steerable vehicle to the path as a function of the determined steering position.

Preferred apparatus of the system and method includes a sensor for sensing the information representative of the steering position of the steerable wheel, and outputting the information representative of the steering position of the steerable wheel. The apparatus includes a controller in connection with the sensor for receiving the information representative of the steering position, and outputting the signal indicative of the corrective steering action to a display device, typically to be located in an operator cab or area of the machine.

According to another preferred aspect of the invention, for a harvesting machine which is a cotton harvester, the at least one steerable wheel comprises a rear wheel of the harvester, and the sensor is disposed for sensing the steering position of the steerable rear wheel. Another possibility for a harvesting machine which is a cotton harvester, is that the at least one steerable wheel comprises a caster wheel located on an end of an unfolded unloading ramp, and the sensor is disposed for sensing the steering position of the caster wheel.

As a preferred display device, the display includes an arrow pointing in a left hand direction which is illuminated when the corrective steering action required is turning the steering wheel to the left; an arrow pointing in a right hand direction which is illuminated when the corrective steering action required is turning the steering wheel to the right; and a center marker which is illuminated when no corrective steering action is required. As an option, the display may use other shapes, or even text, as indicators. An alternative display indicates steering corrections on a liquid crystal display.

Yet another aspect of the invention provides a method for unloading a unitary load from a crop harvesting machine by configuring the harvesting machine in an unloading mode, initiating movement of the harvesting machine along a substantially straight unloading path, determining information representative of a steering position of at least one steerable wheel of the machine, and determining information representative of a condition wherein a steerable wheel of the vehicle is deviating from the path, and displaying a signal indicative of a corrective steering action for returning the steerable vehicle to the path. For this aspect, configuring the harvesting machine in the unloading mode may include unfolding an unloading ramp and tilting a cotton module packager containing the unitary load on the harvesting machine to a tilted position, and moving the unitary load from the cotton module packager onto the unloading ramp.

### BRIEF DESCRIPTION OF THE DRAWINGS

FIG. 1a is a simplified side view of a cotton harvesting machine with a cotton module packager thereof in an unloading position with an unloading ramp thereof in an unfolded unloading configuration;

FIG. 1b is another simplified side view of the cotton harvesting machine of FIG. 1a with the cotton module packager and the unloading ramp in the unloading configuration and showing a unitary cotton module on the ramp at a point just prior to movement onto a surface onto which the unitary cotton module is to be unloaded;

FIG. 1c is another simplified side view of the cotton harvesting machine of FIG. 1a with the cotton module packager and the unloading ramp in the unloading configuration illustrating the machine being moved forwardly along a path and the deposition of the unitary cotton module onto the surface which the unitary cotton module is to be unloaded;

FIG. 2 is a simplified schematic top view of the cotton harvesting machine of FIGS. 1a-1c with the cotton module packager tilted and the unloading ramp unfolded in the unloading configuration illustrating elements of the guidance indicator system of the invention and possible forces or loads that can be exerted against components of the machine while being moved in the forward direction along the unloading path;

FIG. 3 is a diagrammatic representation of elements of the invention in association with elements of the machine of FIGS. 1a-1c, including a sensor in connection with a steerable wheel of the machine, a controller and a display device illustrated in proximity to a steering wheel of the machine located in an operator cab of the machine;

FIG. 4 is a simplified fragmentary side view of an end of an unloading ramp of the cotton harvesting machine and a caster wheel thereof, showing a sensor of the invention in an alternate location; and

FIG. 5 is a high level diagram of steps of operation of the guidance indicator system of the invention.

### DETAILED DESCRIPTION OF THE INVENTION

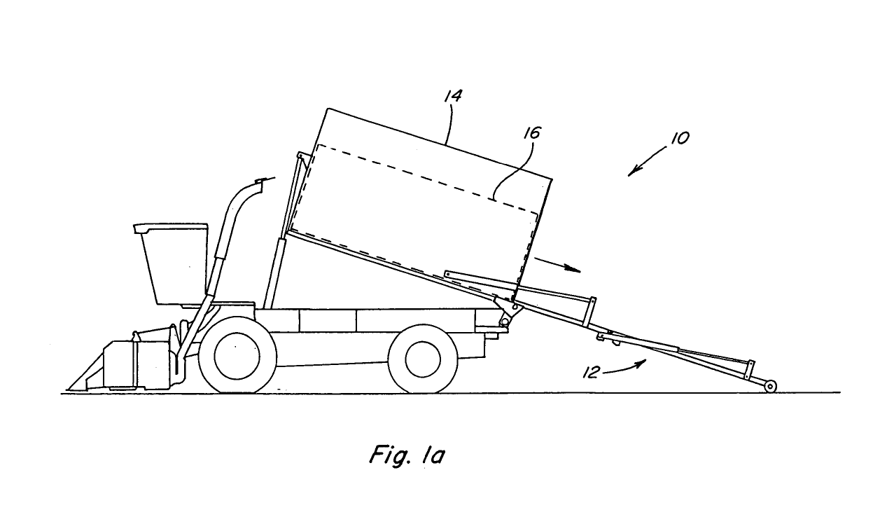

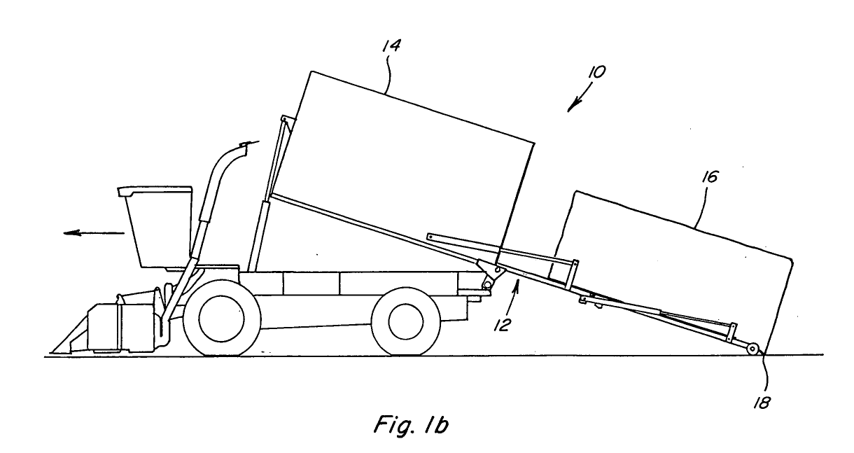

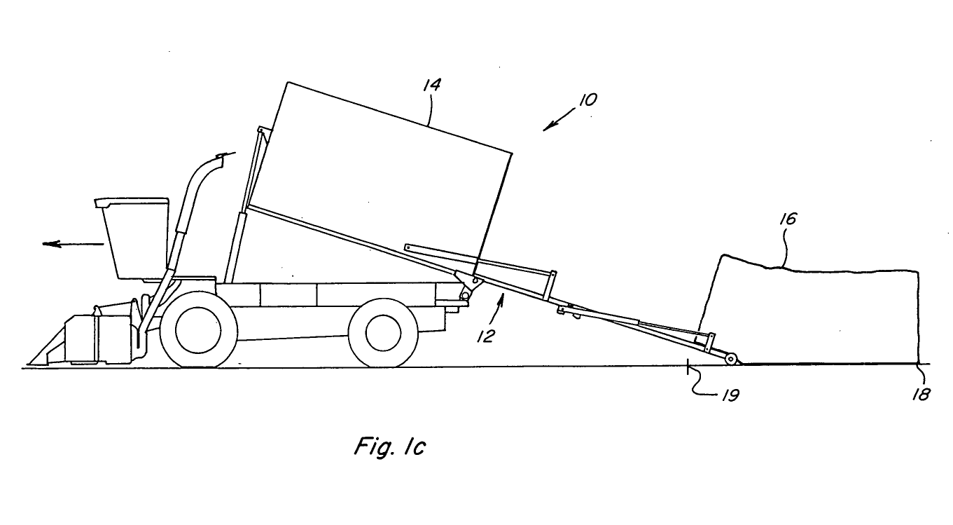

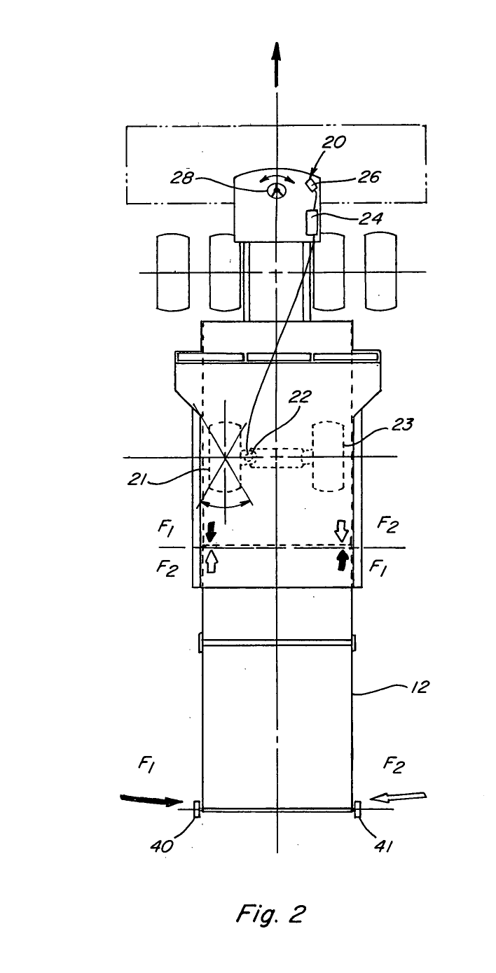

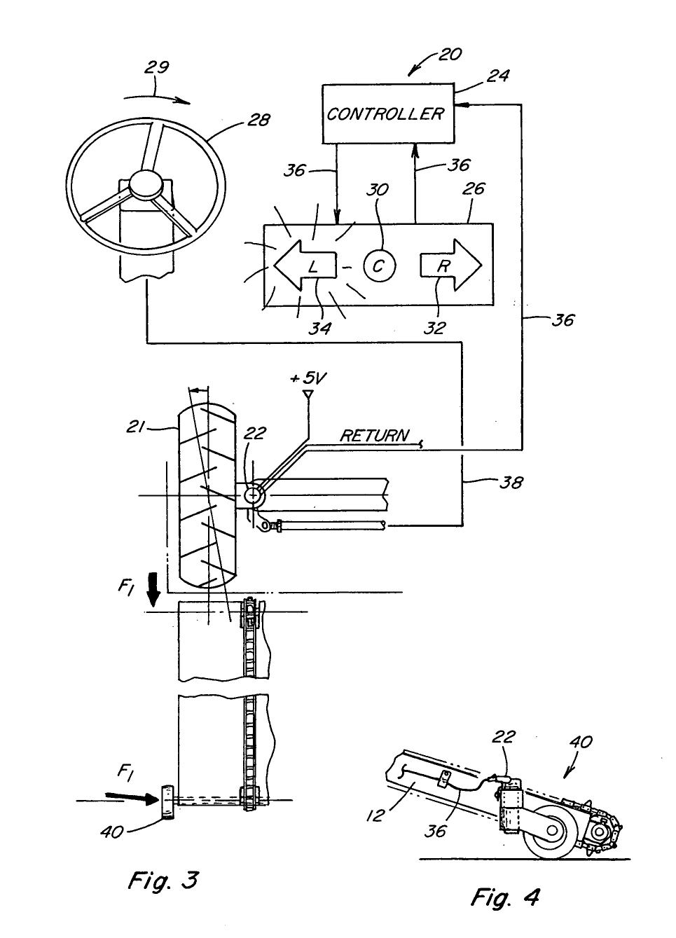

Referencing the drawings, FIGS. 1a-1c show a cotton harvesting machine 10 at various stages of the unloading process. FIG. 1a is a simplified side view of cotton harvesting machine 10 with a cotton module packager 14 and an unloading ramp 12 in an unloading configuration with cotton module packager 14 tilted and unloading ramp 12 unfolded forming a continuous straight inclined path to a surface onto which cotton module 16 is to be unloaded, which can be, for instance, the ground. In FIG. 1a cotton module 16 is inside cotton module packager 14. FIG. 1b depicts cotton harvesting machine 10 after cotton module 16 has moved out of cotton module packager 14 and down unloading ramp 12 to a point 18 at a lower end of unloading ramp 12 where cotton module 16 initially contacts the ground. From point 18 in the unloading process, the path of cotton harvesting machine 10 becomes very important. Essentially, unloading ramp 12 of harvester 10 must move forward in a substantially straight path from point 18 where cotton module 16 makes initial contact with the ground or other surface onto which it is to be unloaded, to a point 19 when cotton module 16 has completely unloaded and cleared unloading ramp 12 to minimize the possibility of damage to cotton module 16 or machine 10, which can result as explained in reference to FIGS. 2 and 3 below. FIG. 1c depicts cotton harvesting machine 10 during the portion of the unloading process in which it is critical to maintain this substantially straight path to prevent possible damage due to side forces on cotton module 16 and unloading ramp 12. In this figure, cotton module 16 is partially on the ground and partially on unloading ramp 12.

As, ramp 12 of cotton harvesting machine 10 moves forward from the condition depicted in FIG. 1b, where cotton module 16 is at point 18 of the unloading path, to point 19 where cotton module 16 is completely unloaded and has cleared unloading ramp 12, the unloading movement of heavy cotton module 16 can significantly shift the weight distribution of cotton harvesting machine 10. This shifting load, along with irregular terrain that may be traversed by machine 10, may make it difficult to drive machine 10 along a straight path with the accuracy desired or required to protect cotton module 16 and unloading ramp 12 from potentially damaging side forces that can be generated by deviating from the path.

FIGS. 2 and 3 illustrate a possible layout configuration of elements of a guidance indicator system 20 constructed and operable according to the teachings of the present invention. In FIG. 2, cotton harvesting machine 10 is depicted with cotton module packager 14 tilted and unloading ramp 12 unfolded in the unloading configuration. The elements of system 20 include a steerable wheel 21, a wheel position sensor 22 that provides information representative of the position of steerable wheel 21, a controller 24 that receives information from wheel position sensor 22 and determines a steering correction, if required, and a display 26 to indicate that steering correction to an operator. Controller 24 also preferably determines when no steering correction is required, and indicates this condition on display 26. Controller 24 may be a conventional controller such as a microprocessor-based controller. Wheel position sensor 22 and display 26 are connected to controller 24 through conductive paths, such as conventional wiring harnesses or a wireless communication system. Steering corrections, as with any steering movements of steerable wheels 21 and 23, are effected by rotation of a steering wheel 28 via conventional apparatus, such as a linkage 38 or the like. Wheel position sensor 22 may be a convention sensor operable for sensing rotary or linear position, such as, but not limited to, a Hall effect sensor, a potentiometer, or the like.

Receiving a real-time proper steering correction to maintain a straight ahead path, particularly as ramp 12 moves from point 18 to point 19 (FIGS. 1b and 1c), is important to minimize the risk of damage to cotton harvesting machine 10 and cotton module 16 during the unloading process. For instance, if harvester 10 moves forward with steerable wheel 21 turned counterclockwise or to the left from the straight ahead position (for turning machine 10 to the right), forces illustrated by thick black arrows F₁ may be exerted on unloading ramp 12. Conversely, if harvester 10 moves forward with steerable wheel 21 turned clockwise or to the right from the straight ahead position (for turning machine 10 to the left), forces illustrated by thick white arrows F₂ may be exerted on unloading ramp 12. These illustrated forces F₁ and F₂ can vary in location, direction, and magnitude, and can create a side loading condition that can potentially damage unloading ramp 12, particularly if heavy cotton module 16 is located thereon. If cotton module 16 is located partially on ramp 12 and partially on the ground or other surface onto which it is to be unloaded, damage to module 16 can result, such as fracturing or splitting. To minimize the possible damage, guidance indicator system 20 automatically indicates the proper steering corrections for the operator to make using steering wheel 28 to minimize or counteract those potentially damaging loads.

When steerable wheel 21 is in a straight ahead position, and it is safe to proceed forward and initiate or continue the unloading process, no steering correction is required, and this condition may be indicated by illuminating a C (center) light 30 on display 26. As vehicle 10 proceeds to move in the forward direction for unloading, conditions such as the shifting weight of cotton module 16, the uneven terrain, an inadvertent steering input, or a combination of these and other factors may cause steerable wheel 21 to deviate from the desired straight ahead path. Guidance indicator system 20 alerts the operator to this condition, and indicates the direction and duration of the steering correction necessary for vehicle 10 to maintain or return to the desired straight ahead path.

In FIG. 3, steering wheel 28 is illustrated turned clockwise by an arrow 29. This turning movement causes steerable wheel 21 to turn counterclockwise resulting in the possible exertion of the above-discussed undesirable forces, illustrated by forces F₁. If no steering correction is made, unloading ramp 12 and cotton module 16 may be damaged by the effects of the side loads associated with forces F₁ created during deviation of vehicle 10 from the desired straight ahead path. To avoid this condition, guidance indicator system 20 provides the operator with steering correction information to help minimize or eliminate exertion of forces on unloading ramp 12 and cotton module 16 during this portion of the unloading process. In operation, wheel position sensor 22 sends information representative of the position of steerable wheel 21 to controller 24 which determines that a counterclockwise or left steering correction is required. Controller 24 outputs a signal to display 26 to turn off C light 30 and illuminate an L (left) arrow 34, as shown in FIG. 3. The operator is alerted by illuminated L arrow 34 on display 26 that a steering correction is required, and that the required correction is turning steering wheel 28 counterclockwise or in the left hand direction. As the steering correction is effected, steerable wheel sensor 22 continues to send information to controller 24 representative of the position of steerable wheel 21. When controller 24 determines the position of steerable wheel 21 is corrected, it outputs a signal to display 26 to turn off L arrow 34 and illuminate C light 30. The operator is thus informed that the correction has been effected when C light 30 is once again illuminated indicating that steerable wheel 21 is once again in the straight ahead position. Similarly, when controller 24 determines a steering correction to the right is required, C light 30 is turned off, and an R (right) arrow 32 is illuminated. Once the steering correction for this condition is completed and controller 24 determines the position of steerable wheel 21 has been corrected R arrow 32 is turned off, and C light 30 is once again illuminated.

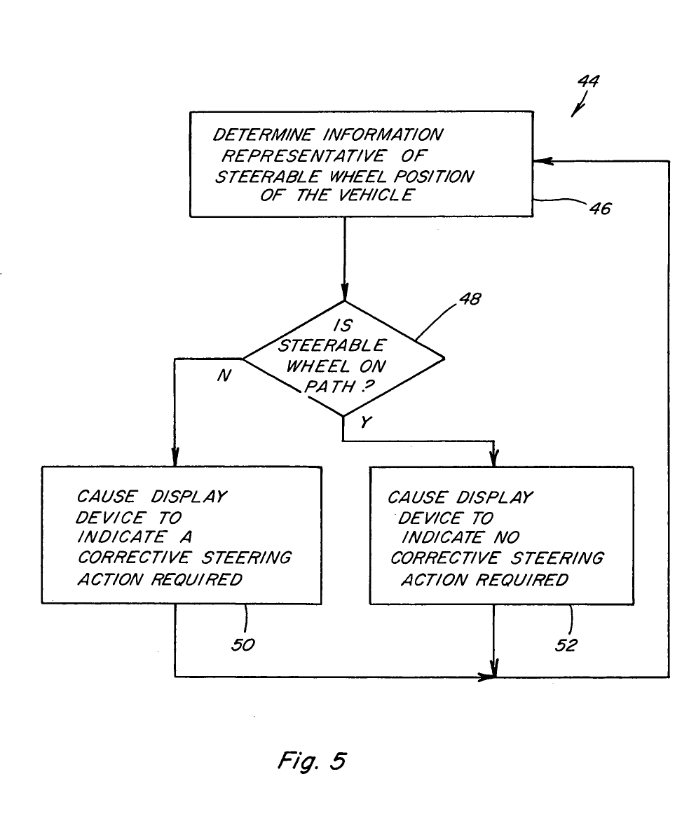

As an alternate location for sensor 22 of guidance indicator system 20, the steering correction required may be determined as a function of the rotational position of a caster wheel 40 or 41 located at the end of unloading ramp 12. Wheels 40 and 41 are lowered to the ground or other surface onto which the cotton module is to be unloaded as unloading ramp 12 unfolds and will roll along the ground or other surface to provide an indicator of direction of movement of the lowered end of ramp 12. FIG. 4 shows sensor 22 located in a position to sense information representative of the rotational position of caster wheel 40. Sensor 22 is connected to controller 24 by conductive path 36, and controller 24 uses the information from sensor 22 to determine a steering correction, if required, and signals display 26 accordingly in the above described manner.

The operator can be alerted to the steering corrections differently in alternate embodiments. For example, an auditory warning system can be used wherein different tones indicate required steering corrections. Another system may have a computerized voice directing the operator to make the required corrections. Alternative display 26 embodiments and indicators may also be used. Rather than an illuminated panel for display 26, the system may use a liquid crystal or other text capable display to indicate steering corrections. Arrows may be replaced by other shapes or text such as, STEER LEFT, STEER RIGHT and WHEELS ARE STRAIGHT, for example. Another possible display may superimpose steering correction indications on the windshield in a heads-up type display.

FIG. 5 is a high level flow diagram 44 of steps of operation of the guidance indicator system 20 of the invention. Block 46 indicates determination of information representative of steerable wheel position of the vehicle. Block 48 is a decision step wherein the system determines whether the steerable wheel is on the path. If the steerable wheel has deviated from the path, block 50 indicates operation of the system to cause a display device to indicate a corrective steering action to return to the desired path. If the steerable wheel is on the path, block 52 indicates operation of the system to cause a display device to indicate no corrective steering action to return to the desired path.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A method for signaling or indicating when a steerable vehicle is varying from a path, comprising steps of:
determining information representative of a steering position of at least one steerable wheel of the vehicle; and
outputting a signal indicative of a corrective steering action for returning the steerable vehicle to the path as a function of the determined steering position.

2. The method of claim 1 comprising additional steps of:
providing a sensor for sensing the information representative of the steering position of the steerable wheel in connection with a controller; and
outputting the information representative of the steering position of the at least one steerable wheel to the controller.

3. The method of claim 2 wherein the controller is operable for receiving the information representative of the steering position of the steerable wheel and outputting the signal indicative of the corrective steering action to a display device.

4. The method of claim 1 comprising additional steps of:
providing a sensor for sensing the information representative of the steering position of the steerable wheel; and
outputting a signal representative of the position to a controller in connection with a display device operable for outputting the signal indicative of the corrective steering action for returning the steerable vehicle to the path.

5. The method of claim 4 wherein the vehicle comprises a cotton harvester and the at least one steerable wheel comprises a rear wheel of the harvester, and the sensor is disposed for sensing the steering position of the steerable rear wheel.

6. The method of claim 4 wherein the display device includes:
an arrow pointing in a left hand direction which is illuminated when the corrective steering action required is a left hand turning movement of an operator controlled steering device;
an arrow pointing in a right hand direction which is illuminated when the corrective steering action required is right hand turning movement of the operator controlled steering device; and
a center marker which is illuminated when the corrective steering action required a lack of movement of the operator controlled steering device.

7. The method of claim 4 wherein the display device includes an illuminatable arrow pointing to the left, an illuminatable arrow pointing to the right and an illuminatable indicator disposed between the arrows, and the controller is operable to illuminate the left arrow when a left hand corrective steering action is required, to illuminate the right arrow when a right hand corrective steering action is required, and to illuminate the center indicator when no corrective steering action is required.

8. The method of claim 4 wherein the display device includes a liquid crystal display with
an arrow pointing in a left hand direction which is activated when the corrective steering action required is a left hand turning movement of an operator controlled steering device;
an arrow pointing in a right hand direction which is activated when the corrective steering action required is right hand turning movement of the operator controlled steering device; and
a center marker which is activated when the corrective steering action required a lack of movement of the operator controlled steering device.

9. The method of claim 4 wherein the display device includes a text message corresponding to the signal indicative of the corrective steering action.

10. A method for unloading a unitary load from a crop harvesting machine comprising the steps of:
configuring the harvesting machine in an unloading mode;
initiating movement of the harvesting machine along a substantially straight unloading path;
determining information representative of a steering position of at least one steerable wheel of the machine; and
determining information representative of a condition wherein the steerable wheel of the vehicle is deviating from the path, and displaying a signal indicative of a corrective steering action for returning the steerable vehicle to the path.

11. The method of claim 10, wherein the step of configuring the harvesting machine in the unloading mode comprises:
unfolding an unloading ramp and tilting a cotton module packager containing the unitary load on the harvesting machine to a tilted position; and
moving the unitary load from the cotton module packager onto the unloading ramp.

12. The method of claim 10, wherein the step of displaying the signal indicative of the corrective steering action comprises illuminating an arrow on a display device on the machine.

13. The method of claim 12, comprising a further step of illuminating a center indicator in the absence of the required steering correction.

14. A system for indicating when a steerable vehicle is varying from a path comprising:
at least one sensor operable for sensing information indicative of a steering position of at least one steerable wheel of the vehicle and outputting a signal when the steerable wheel has varied from the path; and
a controller operable for receiving the signal and outputting a signal to a display device for causing the display device to indicate a corrective steering action for returning the steerable wheel to the path.

15. The system of claim 14, wherein the controller is operable for ceasing the outputting of the signal to the display device when the steerable wheel is on the path.

16. The system of claim 14 wherein the controller is operable for outputting a different signal to the display device indicating when the steerable wheel is on the path.

17. The system of claim 14 wherein the steerable vehicle is a cotton harvester and the at least one steerable wheel comprises a rear wheel of the harvester and the sensor is disposed for sensing information indicative of the position of the steerable rear wheel.

18. The system of claim 14 wherein the steerable vehicle is a cotton harvester and the at least one steerable wheel comprises a caster wheel on an end of an unloading ramp of the harvester and the sensor is disposed for sensing information indicative of the position of the caster wheel.

19. The system of claim 14 wherein the display includes an illuminatable arrow pointing to the left which is illuminated to indicate a left hand steering correction is required, an illuminatable arrow pointing to the right which is illuminated to indicate a right hand steering correction is required, and an illuminatable center indicator which is illuminated to indicate absence of a requirement for a steering correction.
